(19) United States
(12) Patent Application Publication
(10) Pub. No.: US 2011/0067388 A1
(43) Pub. Date: Mar. 24, 2011

(54) DIESEL PARTICULATE FILTRATION (DPF) SYSTEM

(76) Inventor: Xiaogang Zhang, Novi, MI (US)

(21) Appl. No.: 12/565,780

(22) Filed: Sep. 24, 2009

(51) Int. Cl. F01N 3/021; B01D 46/42; B01D 46/46

(52) U.S. Cl. 60/311; 55/422; 96/398

(57) ABSTRACT

A fiber-paper based Diesel particulate Filtration (DPF) apparatus possessing high filtration efficiency and a high porosity, the apparatus comprising at least two rollers capable of rotating over rotors with the help of a controlled motor and capable of supplying fiber paper at the exhaust gas inlet. As the exhaust gas moves over the fiber paper supplied from one of the rollers, the soot gets gradually collected on the fiber paper and keeps on increasing the backpressure thereon. The moment when the backpressure increases beyond a limit, the loaded section of the fiber paper is replaced by fresh fiber paper from the other roller. The loaded fiber is sent to an off-board regeneration facility for regeneration.

### TECHNICAL FIELD

This disclosure relates generally to exhaust gas treatment systems and more particularly to diesel particulate filtration (DPF) systems.

### BACKGROUND

As is known in the art, most current diesel exhaust gas treatment systems today include a DOC (Diesel Oxidation Catalyst) followed by a DPF (Diesel Particulate Filter). The DPF includes a substrate (sometimes referred to as a substrate brick or brick) with the outlet end closed on the inlet channel and the inlet end closed on the outlet channel. Exhaust gas flows through the inlet channel, crosses the wall of cells, and then exits through the outlet channel. The particles are filtrated in the inlet channel.

As is also known in the art, particulate filters are used in the exhaust systems of internal combustion engines, especially diesel engines to trap and remove particulate material (soot), which is primarily formed of carbon, based material. As the engine exhaust passes through the DPF, the particulates are trapped in the filter and accumulate over time. This leads to an increase in the resistance of the exhaust gas flow through the DPF, and therefore, to an increase in the backpressure on the engine. This increase in backpressure has an adverse effect on engine operation, and especially on fuel consumption. In order to reduce backpressure to acceptable levels, the DPF is periodically regenerated by burning off the accumulated particulates, most of which are combustible.

As is also known in the art, a traditional cordierite or SiC DPF system needs to under going a regeneration process to burn out soot (i.e., diesel particulate) collected on the DPF wall surface. A few problems are associated with this procedure: 1. A fuel penalty because diesel fuel is injected either through post injection or down pipe injection to generate high exhaust temperature. Usually fuel penalty is in the range of 3 to 5%; 2. Unevenly distributed soot resulted from poor flow uniformity will lead to high temperature gradient inside DPF substrate, and cause durability issue such as ring-off-crack failure; and 3. Very low or even negative NOx conversion efficiency is found during DPF regeneration, usually takes more than 10 minutes. This is becoming an issue for meeting level III emission requirements.

### SUMMARY

In accordance with the present disclosure, a Diesel Particulate Filtration (DPF) system is provided having a supply of diesel particulate filtering material, a first portion of the material being disposed in a path of exhaust gasses passing through the system to collect diesel particulate in the exhaust gasses, and a motor for moving the first portion of the material out of the path while drawing a second portion of the material from the supply into the path.

In one embodiment, the supply of material is paper.

In one embodiment the material is in a continuous roll.

In one embodiment, the system includes a control system for operating the motor to move the material as a function of measured backpressure.

In one embodiment, the motor operates to move the material when the measured backpressure exceeds a predetermined limit.

In one embodiment, a Diesel Particulate Filtration (DPF) system is provided comprising: a supply of material disposed in a supply region; a collection region; and an electromechanical system for conveying the material in the supply region to collection region with portions of the material between the supply region and the collection region being conveyed through a region separating the inlet section from the outlet section

In one embodiment, a method is provided removing soot from exhaust gases of an internal combustion engine comprising: introducing a first portion of a soot filtering material from a supply of the material into a path of exhaust gasses to collect the soot on the soot filtering material; and subsequently moving the first portion of the material out of the path while moving a second portion of the material from the supply into the path.

In one embodiment, a Diesel Particulate Filtration (DPF) system is provided having a supply roller and a take-up roller; a filter disposed on the supply roller and having an end connected to the supply roller; portions of the filter between the supply roller and the take-up roller passing through exhaust gasses passing through the system; and a motor for moving the portions of the filter between the supply roller and the take-up roller.

In one embodiment, the filter is a fiber paper having a high porosity of about 80% and a high filtration efficiency of about 99%. As the exhaust gas passes through the DPF system, the soot gets collected on an upstream side of the fiber paper.

In one embodiment, a fiber-paper based Diesel particulate Filtration (DPF) apparatus possessing high filtration efficiency and a high porosity, the apparatus comprising at least two rollers capable of rotating over rotors with the help of a controlled motor and capable of supplying fiber paper at the exhaust gas inlet. As the exhaust gas moves over the fiber paper supplied from one of the rollers, the soot gets gradually collected on the fiber paper and keeps on increasing the backpressure thereon. The moment when the backpressure increases beyond a limit, the loaded section of the fiber paper is replaced by fresh fiber paper from the other roller. The loaded fiber is sent to an off-board regeneration facility for regeneration.

With such system and method, as the exhaust gas passes through the DPF system, the soot gets collected on the top of the filter paper. As the mass of soot collected in the filter paper increases, the backpressure across its surface increases gradually. At this point, loaded section of the filter paper is rolled through a controlled motor, and is replaced by fresh fiber paper for soot collection. The loaded filter may be taken to a regeneration facility for burning out the collected soot.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a diagram of an internal combustion engine, here a diesel engine, coupled to an exhaust treatment system, here including a diesel particulate filtration system according to the disclosure;

FIG. 2 is a top view diagrammatical sketch of an internal portion of the diesel particulate filtration system shown in FIG. 1 according to the disclosure, such sketch showing covers for a supply roller and a take-up roller, small guiding rollers, and side guides for the material;

FIG. 3 is a side view showing side guides for the filter material used in the diesel particulate filtration system shown in FIG. 1 according to the disclosure;

FIG. 4 is sketch of one of a pair of guide rollers used in the diesel particulate filtration system shown in FIG. 1 according to the disclosure; and

FIG. 5 is a diagram showing a supply of filter material according to another embodiment of the disclosure.

Like reference symbols in the various drawings indicate like elements.

### DETAILED DESCRIPTION

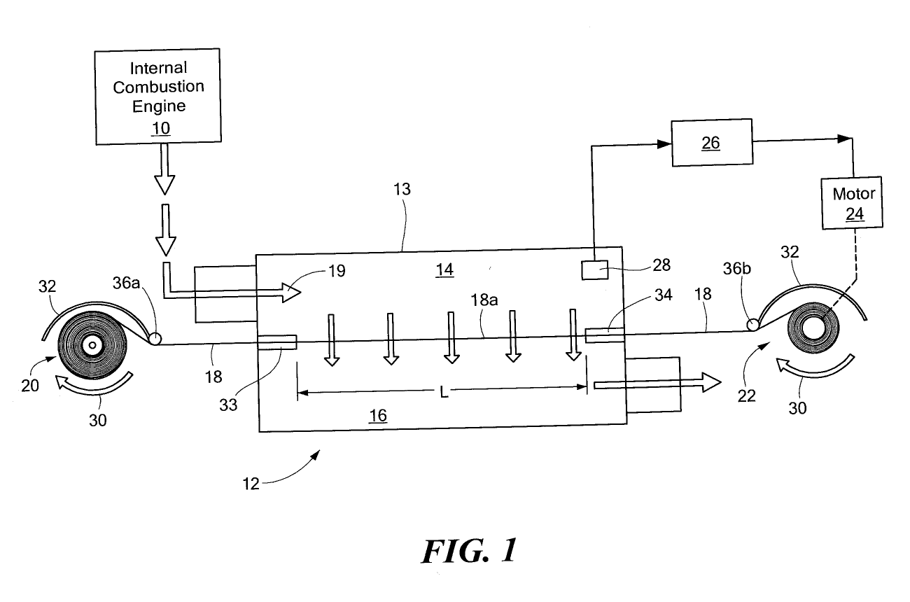

Referring now to FIG. 1, an internal combustion engine 10, here a diesel engine, is coupled to an exhaust treatment system, here including a diesel particulate filtration system 12. The diesel particulate filtration system 12 has housing 13 having an inlet section 14 separated from an outlet section 16 by a portion 18a of a filter material 18 of length L as shown, for removing soot from exhaust gases of 19 the internal combustion engine 10. The filter material 18 is here, for example, a fiber paper having a porosity of fiber paper that may be, for example, larger than 80%, and filtration efficiency as high as 99.9 Due to the elimination of active DPF regeneration, exhaust temperature is below 650 C under all operation conditions. The fiber material can be glass fibers or ceramic fibers which can stand temperature up to 700 C.

The fiber-paper based Diesel particulate Filtration (DPF) system 12 possessing a high filtration efficiency and a high porosity and includes at least two rollers; a supply roller 20 and a take-up roller 22 capable of supplying the portion 18a of the fiber paper 18 in the path of the exhaust gas with the help of an electromechanical system, here an electric motor 24, controlled by a motor controller 26 in response to a measured backpressure in the inlet section 14 sensed by a pressure sensor 28 disposed in the inlet section 14. As the exhaust gas moves over the portion 18a of the fiber paper 18 supplied from the supply roller 20, soot in the exhaust gases 19 gets gradually collected on the portion 18a of the fiber paper 18 resulting in increasing backpressure in the inlet section 14. The moment when the backpressure increases beyond a limit, the motor 24 drives the take-up roller 22, here contraclockwise as shown by the arrow 30 and the portion 18a of the paper 18 is advanced, here to the right one length, L, and the portion of paper between the inlet section 14 and the outlet section 16 is replaced by a new portion 18a of fresh fiber paper 18 from the supply roller 20. Once all the paper is used, the take-up roller 22 with the used paper 18 is sent to an off-board regeneration facility for regeneration.

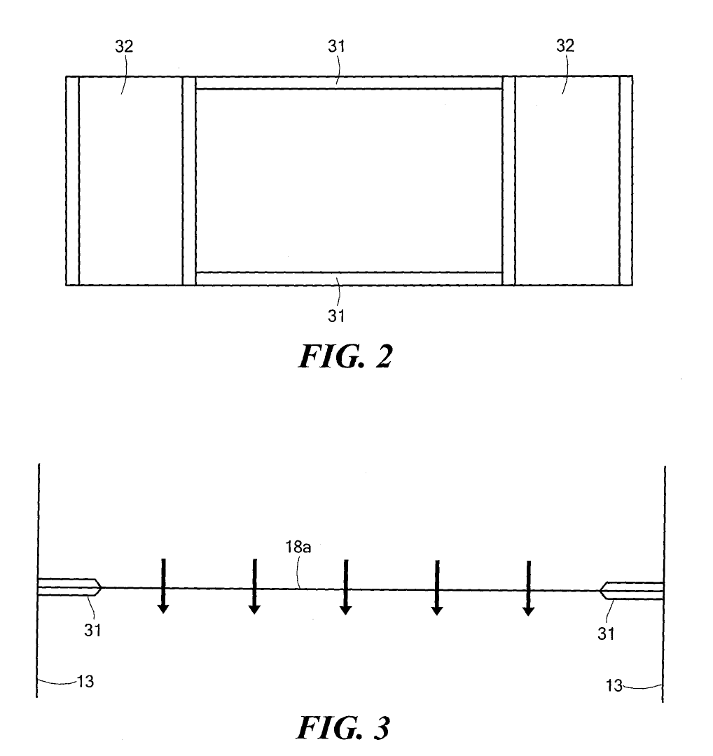

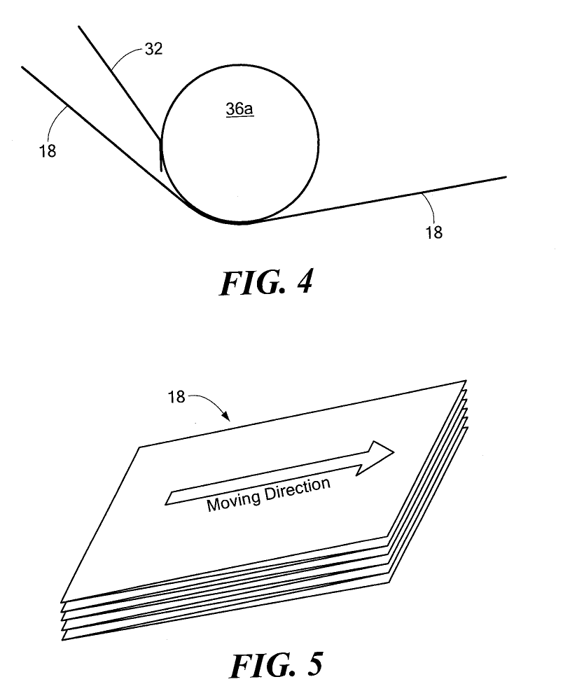

More particularly, referring also to FIGS. 2 and 3, the housing 13 has a pair of side guides 31, a forward guide 32 and a rear guide 34 for receiving the paper 18 as the paper passes through the housing 13. The filter paper 18 is disposed on the supply roller 20 and has an end feed through the forward guide 32, the sides of the feed paper then pass through the pair of side guides 31 and then through the rear guide 34 and the end is then connected to the take-up roller 22. There is a pair of small guiding rotors 36a, 36b as shown in FIG. 4 for rotor 36a. Also shown are covers 32 for the supply roller 20 and the take-up roller 22.

As noted above, portions 18a of the paper 18 between the supply roller 20 and the take-up roller 22 removes soot or diesel particulate in the exhaust gasses 19 passing through the system (passing from the inlet section 14 to the outlet section 16). The motor 24 moves the portion 18a of the paper 18 between the supply roller 20 and the take-up roller 22 under the control of a motor controller 26. The pressure sensor 28 is provided in the inlet section 14 to measure backpressure in the inlet section 14, such backpressure increasing as the amount of soot on the portion 18a of the filter paper increases. The motor controller 26 operates the motor 24 to move the portion 18a of the paper 18 between the supply roller 20 and the take-up roller 22 as a function of backpressure in the system, here measured by the pressure sensor 28. More particularly, the motor controller 26 operates to move the portion 18a of the paper 18 between the supply roller 20 and the take-up roller 22 when the measured back pressure in the system exceeds a predetermined limit as set by a predetermined pressure threshold level. Thus, the portion 18a of the paper between the supply roller 20 and the take-up roller 22 is supplied with fresh paper 18 from the supply roller 20.

The process of advancing the filter paper portion 18a from the supply roller 20 to the take-up roller 22 continues until all the fiber paper 18 on supply roller 20 is used up. Then, the take-up roller 22 is removed for stationery-regeneration facility for burn out the soot and the supply roller 20 is replaced. Additional procedure may be used to clean ash by re-rolling roller 22 to roller 20 with wind power to blow ash away. Roller 20 can be reused. The limitation of backpressure can be easily adjusted by the selection of the threshold pressure level to assure lower backpressure for higher fuel economy.

A number of embodiments of the disclosure have been described. Nevertheless, it will be understood that various modifications may be made without departing from the spirit and scope of the disclosure. For example, other types of filter material may be used. Still further, the supply of material need not be on a roller but may be stacked in sheets as shown in FIG. 5. Further, the supply and take-up may be included within the housing. Accordingly, other embodiments are within the scope of the following claims.

What is claimed is:

1. A Diesel Particulate Filtration (DPF) system comprising: a supply of diesel particulate filtering material, a first portion of the material being disposed in a path of exhaust gasses passing through the system to collect diesel particulate in the exhaust gasses; and a motor for moving the first portion of the diesel particulate filtering material out of the path while drawing a second portion of the diesel particulate filtering material from the supply into the path.

2. The system recited in claim 1 wherein the material is paper.

3. The system recited in claim 1 wherein the supply of material paper is in a continuous roll.

4. The system recited in claim 3 including a control system for operating the motor to move the material as a function of measured backpressure.

5. The system recited in claim 4 wherein the motor operates to move the material when the measured backpressure exceeds a predetermined limit.

6. A method for removing soot from exhaust gases of an internal combustion engine comprising: introducing a first portion of a filter material from a supply of the filter material into a path of exhaust gasses to collect the soot on the material; and subsequently moving the first portion of the material out of the path while moving a second portion of the material from the supply into the path.

7. The method recited in claim 6 wherein the supply is a continuous roll of the material.

8. The method recited in claim 7 wherein the material is moved as a function of measured backpressure.

9. The method recited in claim 8 wherein the material is moved when the measured backpressure exceeds a predetermined limit.

10. A Diesel Particulate Filtration (DPF) system comprising: a supply roller and a take-up roller; a filter material disposed on the supply roller and having an end connected to the supply roller; portions of the material between the supply roller and the take-up roller passing through exhaust gasses passing through the system; and a motor for moving the portions of the material between the supply roller and the take-up roller.

11. The system recited in claim 10 including a control system for operating the motor to move the portions of the material between the supply roller and the take-up roller as a function of measured back pressure in the system.

12. The system recited in claim 11 wherein the motor operates to move the portions of the material between the supply roller and the take-up roller when the measured backpressure in the system exceeds a predetermined limit.

13. The system recited in claim 12 wherein the portions of the material between the supply roller and the take-up roller is supplied with fresh material from the supply roller.

14. A Diesel Particulate Filtration (DPF) system comprising: a supply of filter material, a first portion of the material being disposed in a path of exhaust gasses passing through the system to collect soot in the exhaust gasses; and a motor for moving the first portion of the material out of the path while drawing a second portion of the material from the supply into the path.

15. The system recited in claim 14 wherein the supply of material is in a continuous roll.

16. The system recited in claim 15 wherein the material is a fiber paper material.

17. The system recited in claim 16 wherein the material is a fiber paper having a high porosity of about 80%.

18. The system recited in claim 14 including a control system for operating the motor to move the material as a function of measured backpressure.

19. The system recited in claim 18 wherein the motor operates to move the material when the measured backpressure exceeds a predetermined limit.

20. The system recited in claim 18 wherein the material is a fiber paper material.

21. The system recited in claim 20 wherein the material is a fiber paper having a high porosity of about 80%.

22. A Diesel Particulate Filtration (DPF) system comprising:
a supply of material disposed in a supply region,
a collection region,
an electromechanical system for conveying the material in the supply region to collection region with portions of the material between the supply region and the collection region being conveyed through a region separating the inlet section from the outlet section.

22. The system recited in claim 21 including a control system for operating the electromechanical system to move the material as a function of measured backpressure.

23. The system recited in claim 22 wherein the electromechanical system operates to move the when the measured backpressure exceeds a predetermined limit.
